(19) United States
(12) Patent Application Publication
(10) Pub. No.: US 2015/0161611 A1
(43) Pub. Date: Jun. 11, 2015

(54) Systems and Methods for Self-Similarity Measure

(71) Applicant: SAS Institute Inc., Cary, NC (US)

(72) Inventors: Brian Duke, Cary, NC (US); Mehmet Kerem Muezzinoglu, Cary, NC (US); Ankur Gupta, Cary, NC (US); Vesselin Diev, Cary, NC (US)

(21) Appl. No.: 14/557,009

(22) Filed: Dec. 1, 2014

Related U.S. Application Data
(60) Provisional application No. 62/002,172, filed on May 22, 2014.

(30) Foreign Application Priority Data
Dec. 10, 2013 (IN) 3585/DEL/2013

(51) Int. Cl. G06Q 20/40

(52) U.S. Cl. CPC G06Q 20/4016

(57) ABSTRACT

A computerized system that processes a fraud score for a financial transaction in connection with an account is computed from retrieved data to indicate a probability of the account being in a compromised condition. A self-similarity score is computed if the computed fraud score is above a predetermined threshold to indicate similarity of the received transaction to other transactions of the account in the set of prior transactions. A suggested action to authorize or decline the transaction is determined based on the computed fraud score and the computed self-similarity score.

### CROSS-REFERENCE TO RELATED APPLICATIONS

The present disclosure claims the benefit of priority under 35 U.S.C. §119(e) to U.S. Provisional Application No. 62/002,172 filed May 22, 2014 and titled “Techniques for Self Similarity Measure for Fraud Measurement”, by inventors Brian Duke, et al., the entirety of which is incorporated herein by reference; the present disclosure claims the benefit of priority to India Application No. 3585/DEL/2013 filed Dec. 10, 2013 and titled “Techniques for Self Similarity Measure for Fraud Measurement”, the entirety of which is incorporated herein by reference.

### TECHNICAL FIELD

The present disclosure generally relates to computer-implemented systems and methods for fraud detection systems, data analysis and solutions.

### BACKGROUND

Frequently in fraud detection, financial institutions such as transaction processing agencies and banks may refer to the account of a customer or card owner typically as “the card”, interchangeably with reference to the account and the card itself.

### SUMMARY

The disclosure provides a computer-program product, tangibly embodied in a non-transitory machine-readable storage medium, including instructions configured to be executed to cause a data processing apparatus to perform a method comprising:
retrieving data from data storage of the system in connection with a transaction received at the system relating to an account, wherein the data storage includes data relating to a plurality of accounts, each of which is associated with an account owner, and wherein the collection of accounts comprises an account population;
computing a fraud score in connection with the account to which the received transaction relates, wherein the computed fraud score indicates a probability of the account being in a compromised condition;
computing a self-similarity score in response to a computed fraud score that is above a predetermined threshold, the self-similarity score comprising a similarity measure of the received transaction relative to a set of prior transactions in the data storage relating to the account, wherein the computed self-similarity score indicates similarity of the received transaction to other transactions of the account in the set of prior transactions; and
determining the suggested action based on the computed fraud score and the computed self-similarity score.

The disclosure further provides a computer-program product, wherein determining the suggested action comprises:
determining whether the computed fraud score comprises a high risk score or a low risk score relative to a predetermined threshold risk score value;
determining whether the computed self-similarity score comprises a high similarity score or a low similarity score relative to a predetermined threshold self-similarity score value; and
responsive to determining the fraud score as a high risk score or a low risk score and determining the self-similarity score as a high similarity score or a low similarity score, determining the suggested action.

The disclosure further provides a computer-program product, wherein the determined suggested action comprises contacting a holder of the account without declining the received transaction in response to a computer fraud score that is above a predetermined fraud threshold and a self-similarity score that is above a predetermined similarity threshold.

The disclosure further provides a computer-program product, wherein the determined suggested action comprises declining the transaction, in response to a computer fraud score that is above a predetermined fraud threshold and a self-similarity score that is below a predetermined similarity threshold.

The disclosure further provides a computer-program product, wherein the determined suggested action comprises approving the received transaction, in response to a computer fraud score that is below a predetermined fraud threshold and a self-similarity score that is above a predetermined similarity threshold.

The disclosure further provides a computer-program product, wherein the determined suggested action comprises approving the received transaction and monitoring the account for further activity, in response to a computer fraud score that is below a predetermined fraud threshold and a self-similarity score that is below a predetermined similarity threshold.

The disclosure further provides a computer-program product, wherein computing the self-similarity score comprises utilizing an Alternating Decision Tree.

The disclosure further provides a computer-program product, wherein a confidence margin is associated with the computed similarity score.

The disclosure further provides a computer-program product, wherein the computed self-similarity score comprises a probability that the received transaction is a transaction likely to be initiated by the account holder, regardless of the computed fraud score.

The disclosure further provides a computer-program product, wherein processing time for computing the self-similarity score is not greater than processing time for computing the fraud score.

The disclosure further provides a computer-program product, wherein the computed self-similarity score comprises a measure of proximity of the received transaction relative to a set of prior transactions over a shared data space.

The disclosure further provides a computer-program product, wherein the set of prior transactions in the data storage are included in the retrieved data.

The disclosure further provides a computer-program product, further comprising instructions for providing the suggested action to a financial transaction processing system.

The disclosure further provides a risk assessment computer system, the risk assessment computer system comprising:
a processor; and
a non-transitory computer-readable storage medium that includes instructions that are configured to be executed by the processor such that, when executed, the instructions cause the risk assessment computer system to perform operations including:
   retrieving data from data storage of the system in connection with a transaction received at the system relating to an account, wherein the data storage includes data relating to a plurality of accounts, each of which is associated with an account owner, and wherein the collection of accounts comprises an account population;
   computing a fraud score in connection with the account to which the received transaction relates, wherein the computed fraud score indicates a probability of the account being in a compromised condition;
   computing a self-similarity score in response to a computed fraud score that is above a predetermined threshold, the self-similarity score comprising a similarity measure of the received transaction relative to a set of prior transactions in the data storage relating to the account, wherein the computed self-similarity score indicates similarity of the received transaction to other transactions of the account in the set of prior transactions; and
   determining the suggested action based on the computed fraud score and the computed self-similarity score.

The disclosure further provides a method of operating a risk assessment computer system, the method comprising:
retrieving data from data storage of the system in connection with a transaction received at the system relating to an account, wherein the data storage includes data relating to a plurality of accounts, each of which is associated with an account owner, and wherein the collection of accounts comprises an account population;
computing a fraud score in connection with the account to which the received transaction relates, wherein the computed fraud score indicates a probability of the account being in a compromised condition;
computing a self-similarity score in response to a computed fraud score that is above a predetermined threshold, the self-similarity score comprising a similarity measure of the received transaction relative to a set of prior transactions in the data storage relating to the account, wherein the computed self-similarity score indicates similarity of the received transaction to other transactions of the account in the set of prior transactions; and
determining the suggested action based on the computed fraud score and the computed self-similarity score.

In accordance with the teachings provided herein, systems and methods for automated generation of transaction scores related to financial transactions involving a customer account are provided. The customer account is typically associated with a transaction card or other means of initiating a credit or debit transaction. The customer account will be referred to as “the card” for convenience of discussion. The transaction scores measure the likelihood that the card is currently compromised. This continues to be an aspect of fraud detection. However, for the purpose of talking to customers and explaining actions to them, another aspect is to have a second score that describes how similar a given transaction is to the customer/card/account's previous transaction history. While this measurement may already be a part of the conventional fraud detection score, it has remained inseparable from other aspects in assessment of risk. The technique disclosed herein makes these two transaction score factors separate, so that a financial institution can use multiple factors to control risk and customer experience. The transaction score measurement can be made independent of the assessment of whether the card is currently compromised.

In accordance with the disclosure, a fraud score for a financial transaction in connection with an account is computed from retrieved data to indicate a probability of the account being in a compromised condition. A self-similarity score is computed if the computed fraud score is above a predetermined threshold to indicate similarity of the received transaction to other transactions of the account in the set of prior transactions. A suggested action to authorize or decline the transaction is determined based on the computed fraud score and the computed self-similarity score.

### BRIEF DESCRIPTION OF THE DRAWINGS

FIG. 1 illustrates a block diagram of an example of a computer-implemented environment for automated generation of transaction scores related to financial transactions involving a customer account.

FIG. 2 illustrates a block diagram of an example of a processing system of FIG. 1 for generating one or more transaction scores related to a financial transaction.

FIG. 3 illustrates an example of a flow diagram for generating transaction scores related to financial transactions involving a customer account.

FIG. 4 illustrates another example of a flow diagram for generating transaction scores related to financial transactions involving a customer account.

FIG. 5 illustrates a graphical user interface display that depicts transaction data of an individual with transaction amount along the x-axis and transaction velocity along the y-axis.

FIG. 6 illustrates an example of a graphical user interface display for generating transaction scores related to financial transactions involving a customer account.

Like reference numbers and designations in the various drawings indicate like elements.

### DETAILED DESCRIPTION

This application discloses a method which, in real time, allows for a score to be created that measures the similarity or lack of similarity between a given activity (e.g., a purchase using a credit or debit card) and a set of historical activities for a given card, account, or customer.

Aspects of this particular method can be more individualized in nature. For example, the method can associate a particular activity with a card, account, or customer's previous activity.

Frequently in fraud detection, banks may want to know how similar a given purchase transaction is to a customer's or card's previous purchase history. When a card is compromised by a fraudster, there may be a counterfeit copy of the card being used by the fraudster at the same time a legitimate copy of the card is being used by the legitimate cardholder. The problem is that the bank may wish to decline the transactions that are unusual for the cardholder while approving transactions that are typical for the legitimate cardholder. For example, if a customer goes to the same coffee shop every morning on the way to work, even if his or her card has been compromised and is currently being used by a fraudster, the transactions at the coffee shop should be approved because the bank can be fairly certain that it is the customer, given the customer's long history of visiting this same merchant at similar times of day and amounts to engage in a similar transaction. Rather than decline or approve the transaction, the bank may instead call the customer and ask about any recent suspicious activity. In this situation, the transaction at the coffee shop should not be considered suspicious.

When the card is compromised by a fraudster, there may be a counterfeit copy of the card being used by the fraudster at the same time a legitimate copy of the card is being used by the legitimate cardholder. The problem is that the bank may wish to decline the transactions that are unusual for the cardholder while approving transactions that are clearly made by the legitimate cardholder.

Banks have found that a customer is often irritated when the customer is declined for a transaction and does not understand the reasoning behind the decline. In the above example, if the customer was declined at the coffee shop, the customer would be angry because the customer shops there every day and is accustomed to having no difficulty with the charge. However, if the customer makes an unusual purchase that is something outside of normal spending patterns, then the bank would have an easier time explaining to the customer the reason for being declined.

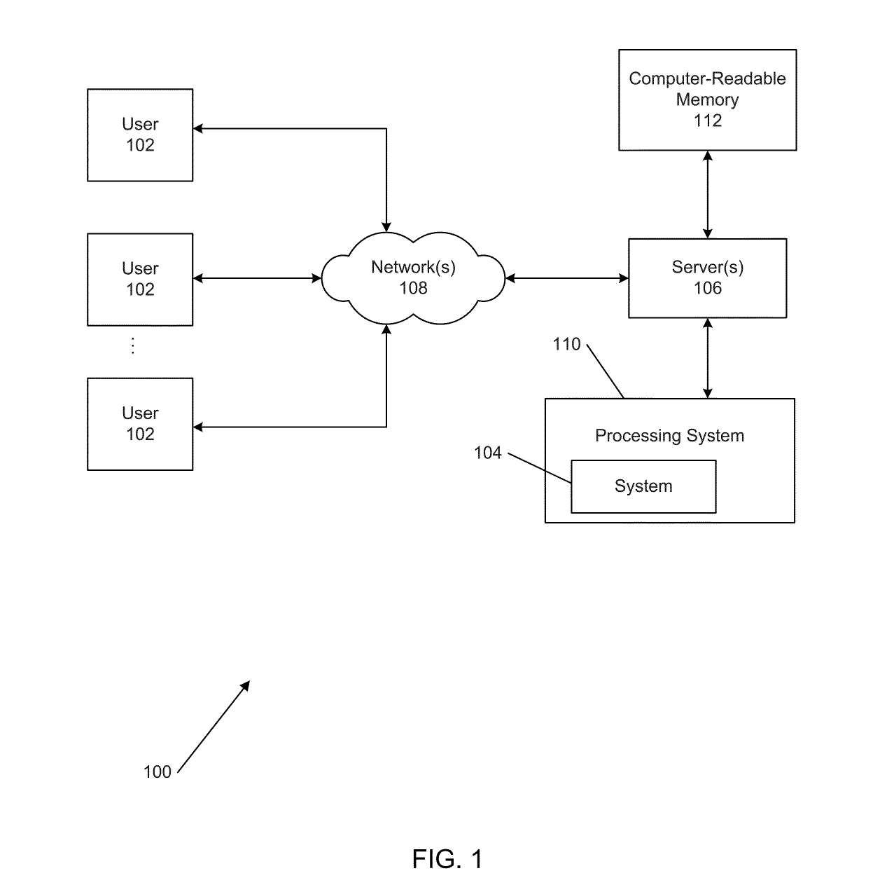

FIG. 1 illustrates a block diagram of an example of a computer-implemented environment 100 for generating transaction scores related to financial transactions involving a customer account. Users 102 can interact with a computer system 104 through a number of ways, such as one or more servers 106 over one or more networks 108. The computer system 104 can contain software operations or routines. That is, the servers 106, which may be accessible through the networks 108, can host the computer system 104 in a client-server configuration. The computer system 104 can also be provided on a stand-alone computer for access by a user. The users may include, for example, a person at a terminal device who is requesting authorization for a financial transaction relating to an account.

In one example embodiment, the computer-implemented environment 100 may include a stand-alone computer architecture where a processing system 110 (e.g., one or more computer processors) includes the computer system 104 on which the processing system is being executed. The processing system 110 has access to a computer-readable memory 112. In another example embodiment, the computer-implemented environment 100 may include a client-server architecture, and/or a grid computing architecture. Users 102 may utilize a personal computer (PC) or the like to access servers 106 running a computer system 104 on a processing system 110 via the networks 108. The servers 106 may access a computer-readable memory 112.

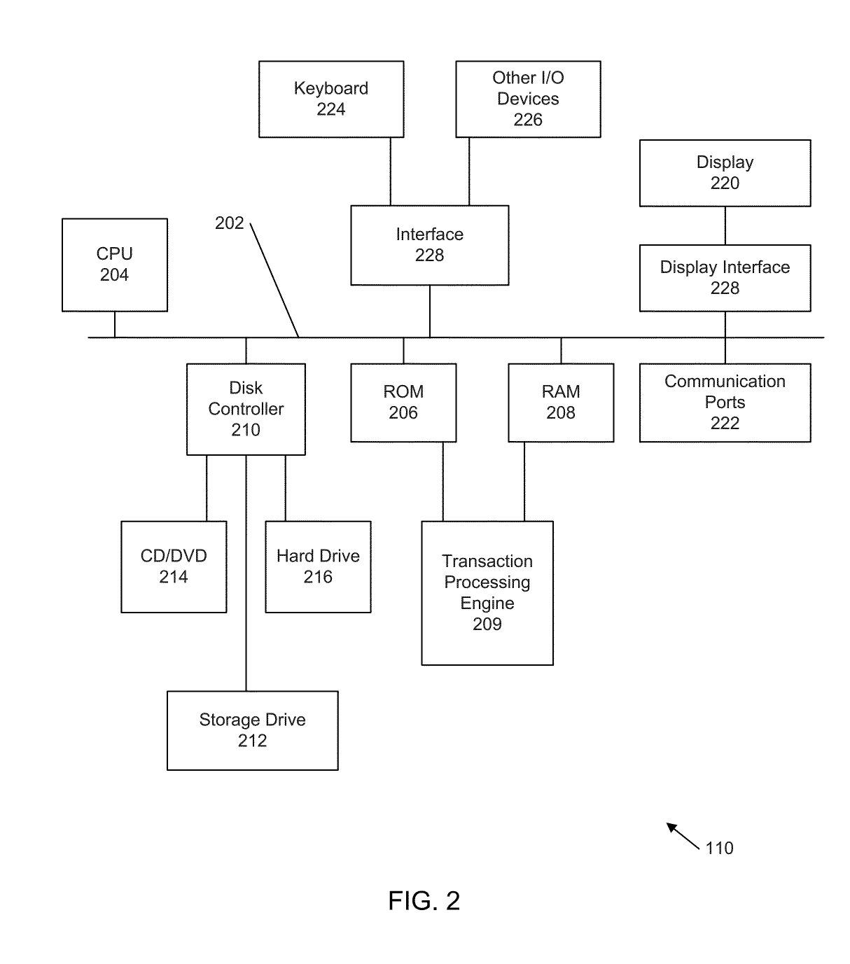

FIG. 2 illustrates a block diagram of an example of a processing system of FIG. 1 for generating transaction scores related to financial transactions involving a customer account. A bus 202 may interconnect the other illustrated components of the processing system 110. A central processing unit (CPU) 204 (e.g., one or more computer processors) may perform calculations and logic operations used to execute a program. A processor-readable storage medium, such as read-only memory (ROM) 206 and random access memory (RAM) 208, may be in communication with the CPU 204 and may contain one or more programming instructions. Optionally, program instructions may be stored on a computer-readable storage medium, such as a magnetic disk, optical disk, recordable memory device, flash memory, or other physical storage medium. Computer instructions may also be communicated via a communications transmission, data stream, or a modulated carrier wave. In one example, program instructions implementing a transaction processing engine 209, as described further in this description, may be stored on storage drive 212, hard drive 216, read only memory (ROM) 206, random access memory (RAM) 208, or may exist as a stand-alone service external to the stand-alone computer architecture.

A disk controller 210 can interface one or more optional disk drives to the bus 202. These disk drives may be external or internal floppy disk drives such as storage drive 212, external or internal CD-ROM, CD-R, CD-RW, or DVD drives 214, or external or internal hard drive 216. As indicated previously, these various disk drives and disk controllers are optional devices.

A display interface 218 may permit information from the bus 202 to be displayed on a display 220 in audio, graphic, or alphanumeric format. Communication with external devices may optionally occur using various communication ports 222. In addition to the standard computer-type components, the hardware may also include data input devices, such as a keyboard 224, or other input/output devices 226, such as a microphone, remote control, touchpad, keypad, stylus, motion, or gesture sensor, location sensor, still or video camera, pointer, mouse or joystick, which can obtain information from bus 202 via interface 228.

As noted above, banks have found that customers may become annoyed and irritated when their transactions are declined and they do not understand the reasoning behind those declined transactions. For example, if the customer's attempt to make a purchase at a coffee shop was declined by the bank, then the customer may be angry if the customer shops there every day. However, if the customer made an unusual purchase that is something outside of the customer's normal spending pattern, with the availability of a self-similarity measure in the bank, it would have an easier time explaining to the customer why the transaction was declined.

Some existing algorithms create scores that measure the likelihood that the card is currently compromised. This can be an aspect of fraud detection. However, another aspect can be to have a second score that describes how similar a given transaction is to the customer/card/account's previous transaction history. This is also useful for the purpose of talking to customers and explaining actions to them. While this self-similarity measurement may be already a part of the conventional fraud detection score, it has remained inseparable from other aspects in our assessment of risk. The disclosed method makes at least these two factors separate so that a bank can use multiple factors to control risk and customer experience. This measurement can be made independently of the assessment of whether the card is currently compromised. In order to do this, we can use technology such as decision trees, PCA (principal component analysis), and CNN (compression neural networks), for example, to create a measure of how similar or dissimilar a given transaction is from a group of previous transactions. Training such a model can be done with or without a target, depending on the needs and desires of the end client.

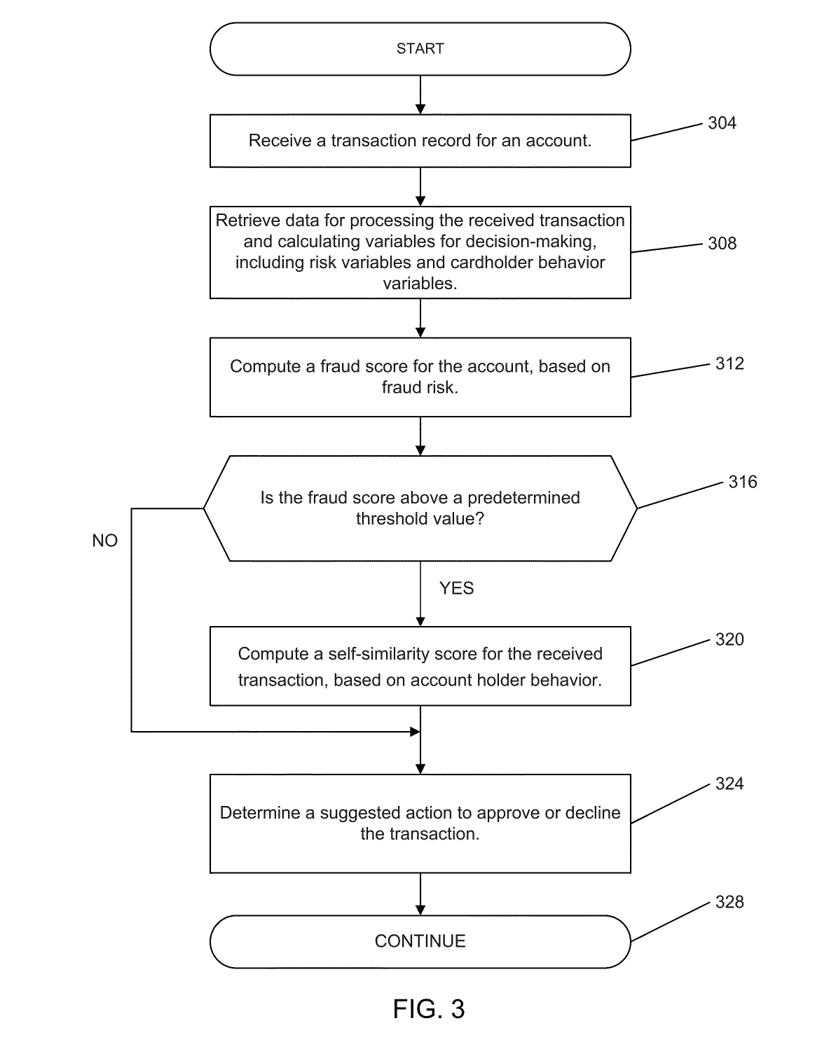

FIG. 3 illustrates an example of a flow diagram for generating transaction scores related to financial transactions involving a customer account, in which a financial transaction such as a purchase is presented by a financial processing system to the computer-implemented environment 100 for an authorization suggestion. In the first operation, illustrated by the box numbered 304, the computer-implemented environment 100 receives a transaction record for an account. The transaction record may comprise, for example, data relating to a purchase transaction for which authorization to charge an account of a customer is requested. The account typically relates to a credit or debit card, or electronic equivalent, for which the customer is obligated to make payment. A customer may have multiple accounts, but each transaction will relate to only one single account, and the customer behavior data discussed below relates to only the account associated with the transaction.

At the next operation, at the box 308 of FIG. 3, the system retrieves data for processing the received transaction and calculates variables for decision-making, including risk variables and cardholder behavior variables. The retrieved data typically includes customer identification data and purchase location data, based on the card account number and the merchant information that typically accompanies the request for authorization of the transaction. The retrieved data also includes risk variables such as risk values associated with the transaction location, transaction amount, time of day, goods or services, and the like. The retrieved data is selected according to decisions of the processing system administrators during configuration of the system. The selection of data to be retrieved includes decisions by the system administrators as to the risk variables that have been deemed important to authorization decision making. That is, the data to be retrieved by the system will be selected by authorized persons during system configuration, in accordance with the user needs for the environment in which the system is being implemented, because the data will be the set of data deemed useful by system administrators in authorization decision making, which data sets will be different for different systems, users, and environments.

The retrieved data also possibly includes cardholder (i.e., account owner) behavior variables, which will typically be in the form of statistical variables, such as typical transaction location, average transaction amount, typical transaction time of day, average amount of goods or services charged, and the like. For example, the “typical transaction location” risk variables may comprise an indicator that compares typical postal codes or addresses or geographic information and determines if the present transaction location corresponds to a postal code or address or other geographic information that indicates a location that is unusually risky from the locations that the user normally frequents. In such an example, an “unusually risky” location is a location at which a determined location risk value (for loss or fraud) is greater than a threshold risk value set by the system implementation. The location-based risk variables as part of a risk determination for a user may include many such “typical transaction locations”, such as locations near the user's residence, near a school, near a work location, and the like. Some other examples could comprise comparison of typical merchants, merchant category code, transaction amount bins, or times of day the user visits those merchants. The degree (e.g., magnitude) of departure from normal behavior may be selected by the processing system according to experience of the degree-of-departure value that corresponds to typically unacceptable risk. This degree-of-departure value for the data, and for the user's behavior, may be measured mathematically using a variety of measures known to those skilled in the art, such as mahalanabolis distance or a discriminant function analysis. The retrieved data is typically retrieved by the processing system from network data storage.

In the next operation, at box 312, the system computes a fraud score for the accounts, based on fraud risk. The fraud score is a score based on a data model such as a neural network. Those skilled in the art will appreciate and understand the data models that are typically employed for calculating a fraud score. The fraud score computed at the box 312 is based on the retrieved data and calculated data variables from the operation at box 308.

In the next operation, at the decision box 316, the system determines if the fraud score is above a predetermined threshold value. The threshold value is determined by system administrators during configuration of the system after considering the number of alerts per day the bank works on typically. That is, the threshold value will be different for different system implementations, depending on the number of alerts typically experienced by the bank, or financial institution, for which the system is implemented. Those skilled in the art will be able to determine an appropriate value for the threshold in view of their system experience and any experimental efforts. If the fraud score is above the threshold value, an affirmative outcome at the decision box 316, then the system processing proceeds to box 320, where the system computes a self-similarity score for the received transaction, based on the account holder behavior.

The self-similarity score comprises a metric that is a measure of the similarity of the transaction being presented for authorization to the other transactions in the owner's purchase behavior history. That is, the self-similarity score is a score that is relevant to the card, account, or customer's past transaction behavior, relating to the purchase transaction for which authorization is requested (see box 304), and the self-similarity score is not a system-wide or card population metric. The self-similarity score may be, for example, a rank ordering of numbers that indicates how similar a transaction is to the previous history of the user. Thus, the self-similarity score relates to the behavior of the account owner, not of other persons who may have different spending patterns and different transaction history. The behavior history of the account owner will also be referred to as the “user's behavior history”, for convenience. The set of other, prior transactions in the account owner's purchase behavior history may be included in the data retrieved in the operation of box 304, or may be retrieved in an additional, subsequent operation. Basing the self-similarity score on all prior transactions (i.e., raw data) is more useful than retrieving a summary of the prior transactions, because the raw data includes more information than would a summary. Following computation of a self-similarity score that is below the threshold, operation proceeds to the box 324, where the system determines a suggested action to approve or decline the transaction. That is, the computed score corresponds to a suggestion for either approving or denying authorization of the retrieved financial transaction. The suggested action may be provided to the transaction processing system of the account owner or retail location.

If the fraud score is not above the predetermined threshold value, a negative outcome at the decision box 316, the system forgoes computing the self-similarity score and instead system operation proceeds directly to determining a suggested action at the box 324. That is, a fraud score above the predetermined threshold indicates a transaction of greater than tolerable risk, but if the fraud score does not indicate too great a risk, then the self-similarity score at box 320 is not computed. In that situation, the suggested action will not be determined in response to a risk transaction. It should be noted that the suggested action is merely a suggestion; the decision to deny or authorize the transaction may be dependent on the bank or other financial institution from whom authorization is being requested by the financial transaction processing system. Such financial institutions determine how to utilize the provided fraud score and self-similarity score to improve fraud detection or reduce false positive warnings.

In the data operations illustrated in FIG. 3, multiple variable types are utilized in computing the metrics of the fraud score and the self-similarity score. For example, some of the data types are based on risk (e.g., the historical risk of a given merchant in a given location), and some data types are based on individual customer behavior (e.g., how frequently has the customer shopped at the given merchant in the given location). In general, if a variable is based on customer behavior but is still risk-related (e.g., the risk associated with frequency of purchases, by all customers, at a given merchant in a given location), then that variable belongs to the risk-based variables and is subsequently not used in the self-similarity score model.

The fraud score is computed using both types of data variables. The fraud score may be typically computed after significant pre-processing such as discretizing, transformations, imputation, normalization, and the like. The fraud score is a score indicating the probability of a card or an account being in a compromised state. Such a model typically selects and uses more risk-based variables than customer-behavior variables.

The self-similarity score utilizes only the user-behavior variables, typically without any of the above-mentioned pre-processing. The user-behavior variables are used in a customer similarity model, typically an alternating decision tree type of model. A score that indicates the probability that the current transaction is similar to the normal card, account, or customer behavior is generated. It should be noted that the self-similarity score is computed with respect to a particular transaction, whereas the fraud score is computed with respect to whether the entire card/account is in a compromised state.

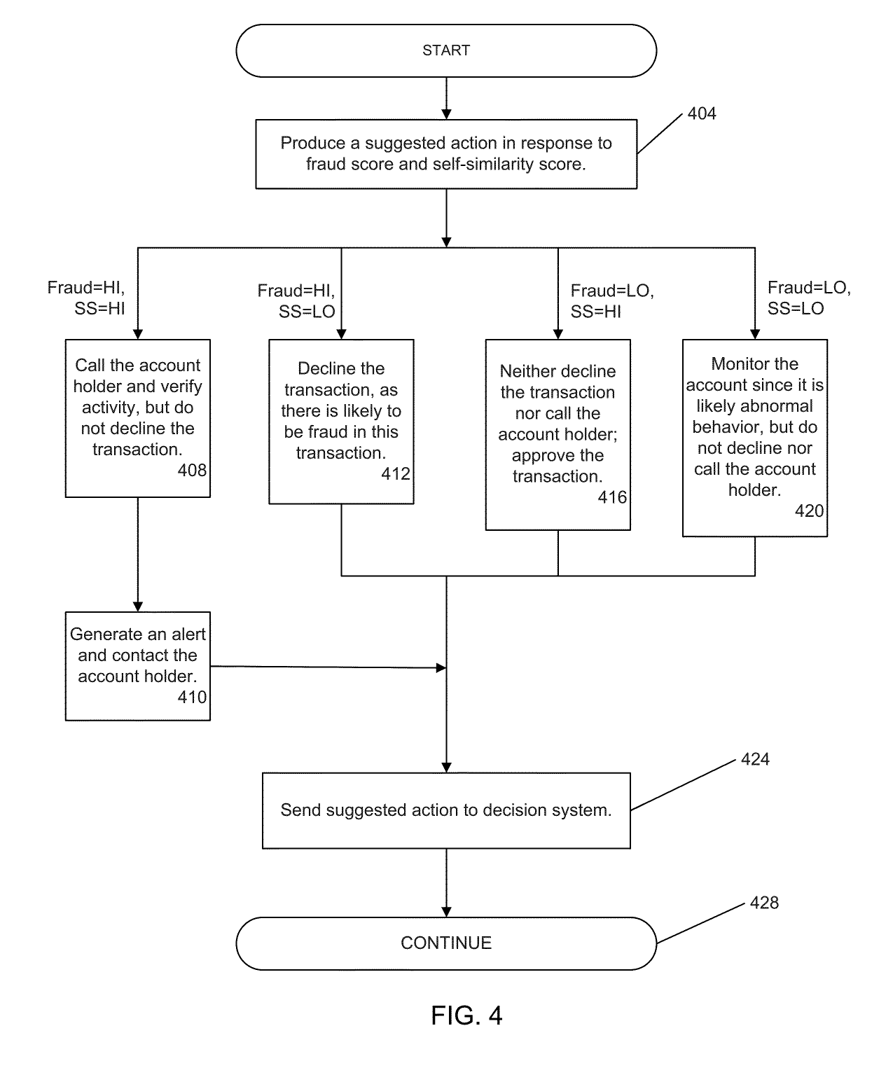

FIG. 4 illustrates another example of a flow diagram for generating transaction scores related to financial transactions involving a customer account. The FIG. 4 operation illustrates how the computer-implemented environment 100 (FIG. 1) will respond to various combinations of fraud score and self-similarity score to provide a suggested response with respect to the transaction submitted for authorization, with initiation of the suggestion processing represented by the box 404. For example, the combinations of fraud score and self-similarity score may comprise a fraud score that is rated high and also a self-similarity score that is rated high, or may include a high fraud score and a low self-similarity score, or may comprise a low fraud score and a high self-similarity score, or may comprise a low fraud score and a low self-similarity score. In this context, “high” and “low” scores are relative terms and could vary from bank to bank. That is, precise definitions or numerical values of “high” and “low” scores may vary among financial institutions such as banks, because they have different operating ranges in terms of numbers of alerts they can each create and process per day. Therefore, a bank can define what is meant by these “high” and “low” scores depending on their operating capacity.

The first produced suggested action, in response to a high fraud score and high self-similarity score, occurs at box 408, where the system suggests a call to the account holder to verify the financial transaction activity, but the system does not suggest declining to authorize the transaction in this situation, because the high self-similarity score indicates that the transaction might, in fact, be initiated by the actual account owner. In conjunction with suggesting to contact the account owner but not decline the transaction, the system responds to a high fraud score and high self-similarity score by action to the transaction processing system for generating an alert and sending a message to contact the account holder at box 410. Processing then continues by the system sending the suggested action to the financial transaction decision system at the box 424. Operation of the system then continues at the box 428.

The next situation, at box 412, occurs when the fraud outcome is high and the self-similarity score is low. At the box 412, the processing system suggests to decline the transaction, as there is likely to be fraud involved in the transaction submitted for review, because the transaction does not support a sufficient similarity to the account owner's history of transaction behavior. Processing then continues by the system sending the suggested action to the financial transaction decision system at box 424, followed by continued operation at the box 428.

In the third pair of score outcomes, a low fraud score and a high self-similarity score, at box 416 the system suggests to neither decline the transaction nor call the account owner. In this situation, the system suggests to approve the transaction because the fraud risk is low and the submitted transaction is consistent with the account owner's prior behavior. Processing then continues with sending the suggested action to the decision system of the processor, at box 424, followed by continued operation of the system at the box 428.

In the fourth pair of outcomes, a low fraud score and a low self-similarity score, at the box 420 the system suggests monitoring the account, without declining the authorization and without contacting the account owner, because the low fraud score and high self-similarity score indicate it is likely abnormal behavior, but there is not a great risk of a fraudulent transaction. Processing then continues with sending the suggested action to the decision system of the financial transaction processor, at the box 424, followed by continuation of operation at the box 428.

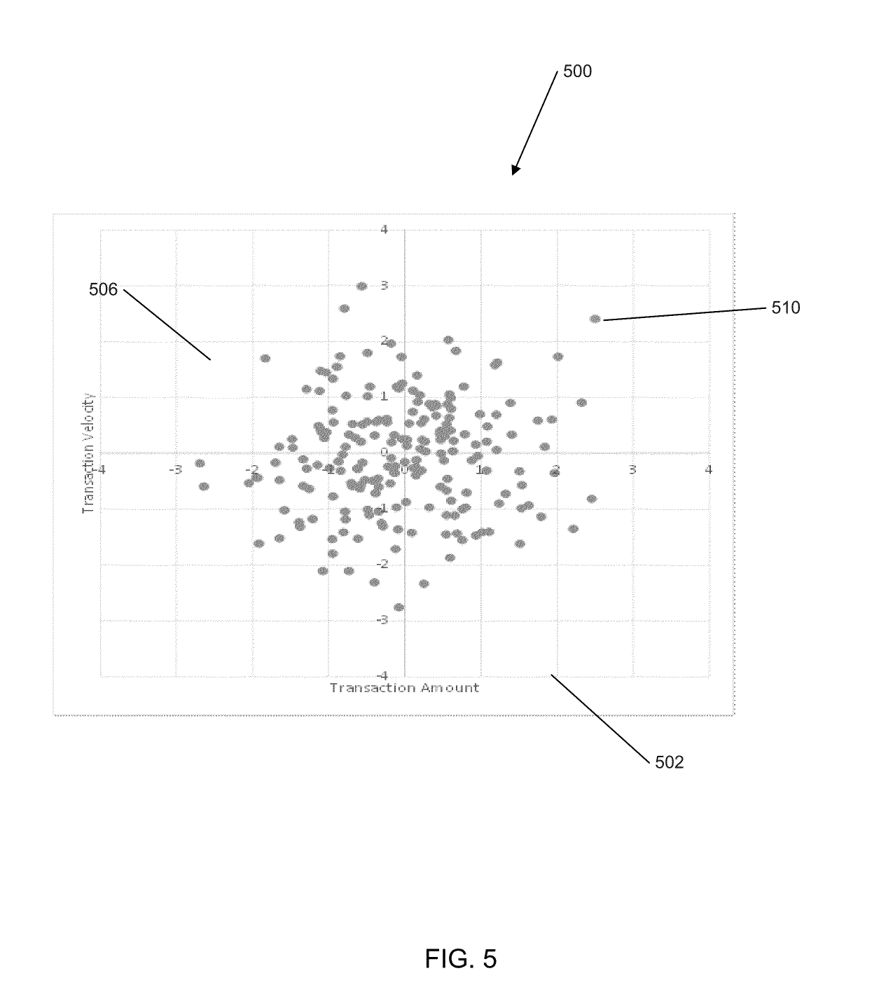

FIG. 5 illustrates a graphical user interface display 500 that depicts transaction data of an individual with transaction amount along the horizontal x-axis 502 and transaction velocity along the vertical y-axis 506. “Velocity” in FIG. 5 is a measure of the frequency of the account transactions. More particularly, the numerical data for transaction amounts and for transaction velocity are z-scaled and thus centered at (0, 0) for each quantity. That is, numerical data of “0” (zero) represents the average for that quantity (i.e., amounts, or velocity) for a given account/customer. After z-scaling on the customer/account level, both the transaction amount and transaction velocity are centered to (0,0), which are the mean/average values for each respective quantity for that customer/account. A higher (in the positive direction) transaction amount represents a transaction of a higher amount than average for the particular user account. A lower transaction amount represents a transaction of a lower amount than average. Similarly, a higher (positive) transaction velocity represents a higher transaction velocity for that user account. A lower transaction velocity represents a transaction velocity of a lower amount than average. It has been determined that the number of account transactions typically needed to determine a reliable self-similarity score can be collected in approximately one month of transactions by a typical customer or in a typical user account.

The chart of FIG. 5 is useful for illustration, for visualization of the data operations, but the chart is not a requirement for operations nor is it used in the decision-making process for authorization or computation of the self-similarity score. In the chart in the display 500 of FIG. 5 for Transaction Velocity versus Transaction Amount, the dots of the chart represent data points that show a customer's normal transaction history, with a concentration of dots (data points) toward the center of the display 500, where transaction amount and transaction velocity are somewhat related. The outlying dot 510, in the upper right section of the display, represents the point where an example (newest transaction) is currently being processed. Being an outlying dot, away from the cluster at the origin (0,0), the new dot 510 is somewhat farther away from the customer's normal behavior, represented by the center of the display 500. Such a relationship could be one of many indicators that this particular purchase transaction is unusual for the account owner customer. If this particular purchase were also a medium to high fraud risk, then it could be logical to decline the transaction, because it would represent a high fraud risk. Even if it was a false positive (i.e., not really a fraud situation), the status of the transaction as a data outlier could make it easier to explain to the account owner customer why the response to the transaction authorization was to decline.

If the outlier dot 510 were located in the middle of the clustered dots, closer to the chart origin (0,0) point, then the transaction represented by the dot 510 would be very similar to other transactions previously made by the customer. If this transaction was a medium or high fraud risk, this new measure (i.e., from a method described herein) may reduce the likelihood of a “decline” suggestion. This is because it may be unwise to decline the transaction indicated with dot 510, because if it was a false positive (i.e., not really fraud), at least because the customer may become frustrated with their experience and decide to bank elsewhere.

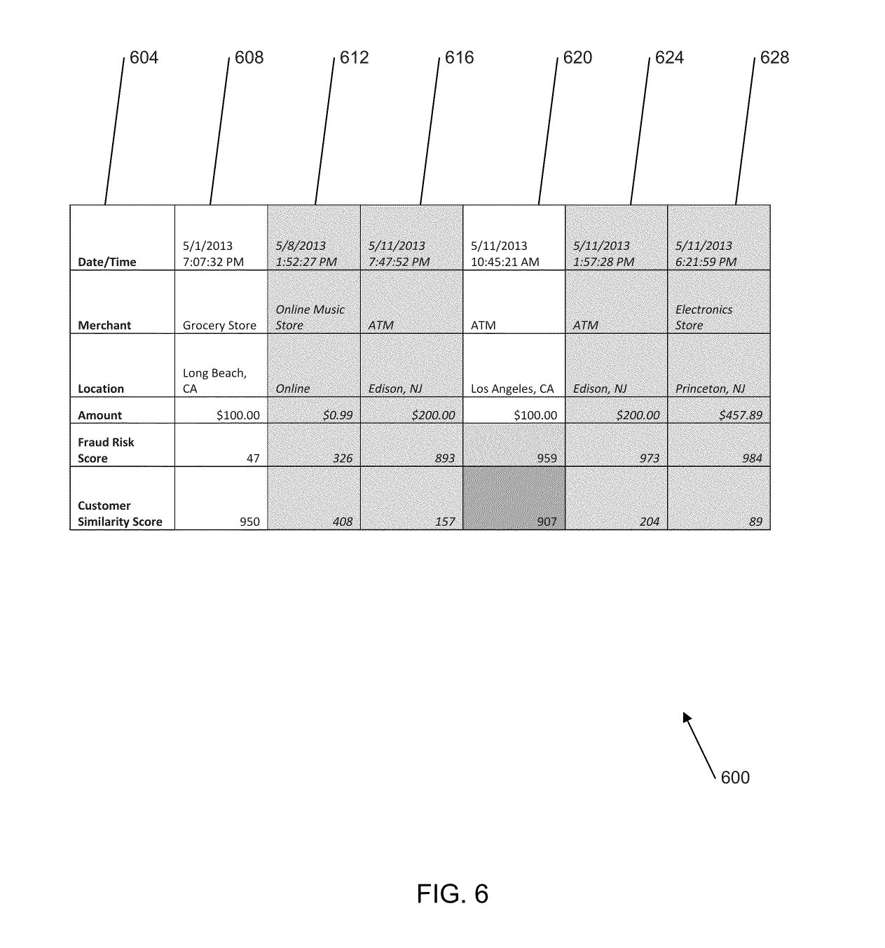

In the table 600 of FIG. 6, transactions and attempted authorizations are detailed, indicated by rows in the left column 604 having row headings of Date/Time, Merchant, Location, Amount, Fraud Risk Score, and Customer Similarity Score. The table 600 represents multiple transactions with corresponding indications of reliability and of attempted fraud, as will now be described further.

The table 600 shows a customer who resides in Long Beach, Calif., USA and who engaged in a legitimate transaction, represented by the first data column 608. The table 600 also indicates that authorization attempts were made by a fraudster, indicated by the columns 612, 616, 624, and 628 (text in italics). The ATM transaction 620 at 10:45 AM is a legitimate transaction, as may be seen from the relatively high self-similarity score and the geographic proximity to the account owner's location.

Without the customer self-similarity score (i.e., from the technique described herein) that is indicated in the bottom row of the table 600, all transactions beginning with the 10:45 AM ATM transaction would probably be declined, even though the 10:45 AM transaction is a legitimate customer transaction. The customer likely would be irritated to find the ATM transaction declined, because the ATM transaction is in the relatively local area, at an ATM that is commonly used by the customer.

With the advent of the customer similarity score, as indicated in the bottom row of the data table 600, although the fraud risk score indicates that the card is most likely currently compromised, the customer similarity score indicates that this particular transaction 620 is a “normal” behavior for the account owner, and is not a data outlier. This additional score, the self-similarity score, gives the financial institution additional information that can be used in deciding whether or not to decline the ATM withdrawal transaction at 10:45 AM, even though there is currently a high fraud risk for the card.

The table below (Table 1) lists examples of some of the scenarios and corresponding benefits that this new score will provide to the bank strategy, which are also described in connection with FIG. 4 above.

TABLE 1

| Customer | Fraud | |
|---|---|---|
| Similarity | Risk | |
| Score | Score | Strategy Benefit |
| HI | HI | False positive reduction. |
| HI | LO | Increases confidence that transaction is legitimate. |
| LO | HI | Increases confidence that transaction is fraud. |
| LO | LO | Likely change in customer spending behavior or a |
| | | fraudulent transaction not catchable by current fraud |
| | | risk score. An increase in volume of these than |
| | | usual may indicate fraud risk score is no longer as |
| | | much effective. |

In some embodiments, this method can help to address the problem when a customer finds out that their card is compromised, the bank issues a replacement card, and the customer cannot use any cards (or maybe even their account) until they receive their new card. With this disclosed method, the customer can still use the compromised card to keep transacting legitimate transactions until the new card arrives and is activated.

### Embodiments

Systems and methods according to some examples may include data transmissions conveyed via networks (e.g., local area network, wide area network, Internet, or combinations thereof, etc.), fiber optic medium, carrier waves, wireless networks, etc. for communication with one or more data processing devices. The data transmissions can carry any or all of the data disclosed herein that is provided to, or from, a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The system and method data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, removable memory, flat files, temporary memory, databases, programming data structures, programming variables, IF-THEN (or similar type) statement constructs, etc.). It is noted that data structures may describe formats for use in organizing and storing data in databases, programs, memory, or other computer-readable media for use by a computer program.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows and figures described and shown in this specification can be performed by one or more programmable processors executing one or more computer programs to perform functions by operating on input data and generating output.

Generally, a computer can also include, or be operatively coupled to receive data from or transfer data to, or both, one or more mass storage devices for storing data (e.g., magnetic, magneto optical disks, or optical disks). However, a computer need not have such devices. Moreover, a computer can be embedded in another device, (e.g., a mobile telephone, a personal digital assistant (PDA), a tablet, a mobile viewing device, a mobile audio player, a Global Positioning System (GPS) receiver), to name just a few. Computer-readable media suitable for storing computer program instructions and data include all forms of nonvolatile memory, media and memory devices, including by way of example semiconductor memory devices (e.g., EPROM, EEPROM, and flash memory devices); magnetic disks (e.g., internal hard disks or removable disks; magneto optical disks; and CD ROM and DVD-ROM disks). The processor and the memory can be supplemented by, or incorporated in, special purpose logic circuitry.

The computer components, software modules, functions, data stores and data structures described herein may be connected directly or indirectly to each other in order to allow the flow of data needed for their operations. It is also noted that a module or processor includes, but is not limited to, a unit of code that performs a software operation, and can be implemented, for example, as a subroutine unit of code, or as a software function unit of code, or as an object (as in an object-oriented paradigm), or as an applet, or in a computer script language, or as another type of computer code. The software components or functionality may be located on a single computer or distributed across multiple computers depending upon the situation at hand.

The computer may include a programmable machine that performs high-speed processing of numbers, as well as of text, graphics, symbols, and sound. The computer can process, generate, or transform data. The computer includes a central processing unit that interprets and executes instructions; input devices, such as a keyboard, keypad, or a mouse, through which data and commands enter the computer; memory that enables the computer to store programs and data; and output devices, such as printers and display screens, that show the results after the computer has processed, generated, or transformed data.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products (i.e., one or more modules of computer program instructions encoded on a computer-readable medium for execution by, or to control the operation of, data processing apparatus). The computer-readable medium can be a machine-readable storage device, a machine-readable storage substrate, a memory device, a composition of matter effecting a machine-readable propagated, processed communication, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question (e.g., code that constitutes processor firmware, a protocol stack, a graphical system, a database management system, an operating system, or a combination of one or more of them).

While this disclosure may contain many specifics, these should not be construed as limitations on the scope of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be utilized. Moreover, the separation of various system components in the implementations described above should not be understood as requiring such separation in all implementations, and it should be understood that the described program components and systems can generally be integrated together in a single software or hardware product or packaged into multiple software or hardware products.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and score. Some systems may use SAS In-Memory Statistics for Hadoop® to read big data once and analyze it several times by persisting it in-memory for the entire session.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-program product tangibly embodied in a non-transitory machine-readable storage medium, including instructions configured to be executed to cause a data processing apparatus to perform a method comprising:
retrieving data from data storage of the system in connection with a transaction received at the system relating to an account, wherein the data storage includes data relating to a plurality of accounts, each of which is associated with an account owner, and wherein the collection of accounts comprises an account population;
computing a fraud score in connection with the account to which the received transaction relates, wherein the computed fraud score indicates a probability of the account being in a compromised condition;
computing a self-similarity score in response to a computed fraud score that is above a predetermined threshold, the self-similarity score comprising a similarity measure of the received transaction relative to a set of prior transactions in the data storage relating to the account, wherein the computed self-similarity score indicates similarity of the received transaction to other transactions of the account in the set of prior transactions; and
determining the suggested action based on the computed fraud score and the computed self-similarity score.

2. The computer-program product of claim 1, wherein determining the suggested action comprises:
determining whether the computed fraud score comprises a high risk score or a low risk score relative to a predetermined threshold risk score value;
determining whether the computed self-similarity score comprises a high similarity score or a low similarity score relative to a predetermined threshold self-similarity score value; and
responsive to determining the fraud score as a high risk score or a low risk score and determining the self-similarity score as a high similarity score or a low similarity score, determining the suggested action.

3. The computer-program product of claim 1, wherein the determined suggested action comprises contacting a holder of the account without declining the received transaction in response to a computer fraud score that is above a predetermined fraud threshold and a self-similarity score that is above a predetermined similarity threshold.

4. The computer-program product of claim 1, wherein the determined suggested action comprises declining the transaction, in response to a computer fraud score that is above a predetermined fraud threshold and a self-similarity score that is below a predetermined similarity threshold.

5. The computer-program product of claim 1, wherein the determined suggested action comprises approving the received transaction, in response to a computer fraud score that is below a predetermined fraud threshold and a self-similarity score that is above a predetermined similarity threshold.

6. The computer-program product of claim 1, wherein the determined suggested action comprises approving the received transaction and monitoring the account for further activity, in response to a computer fraud score that is below a predetermined fraud threshold and a self-similarity score that is below a predetermined similarity threshold.

7. The computer-program product of claim 1, wherein computing the self-similarity score comprises utilizing an Alternating Decision Tree.

8. The computer-program product of claim 1, wherein a confidence margin is associated with the computed similarity score.

9. The computer-program product of claim 1, wherein the computed self-similarity score comprises a probability that the received transaction is a transaction likely to be initiated by the account holder, regardless of the computed fraud score.

10. The computer-program product of claim 1, wherein processing time for computing the self-similarity score is not greater than processing time for computing the fraud score.

11. The computer-program product of claim 1, wherein the computed self-similarity score comprises a measure of proximity of the received transaction relative to a set of prior transactions over a shared data space.

12. The computer-program product of claim 1, wherein the set of prior transactions in the data storage are included in the retrieved data.

13. The computer-program product of claim 1, further comprising instructions for providing the suggested action to a financial transaction processing system.

14. A risk assessment computer system, the risk assessment computer system comprising:
a processor; and
a non-transitory computer-readable storage medium that includes instructions that are configured to be executed by the processor such that, when executed, the instructions cause the risk assessment computer system to perform operations including:
retrieving data from data storage of the system in connection with a transaction received at the system relating to an account, wherein the data storage includes data relating to a plurality of accounts, each of which is associated with an account owner, and wherein the collection of accounts comprises an account population;
computing a fraud score in connection with the account to which the received transaction relates, wherein the computed fraud score indicates a probability of the account being in a compromised condition;
computing a self-similarity score in response to a computed fraud score that is above a predetermined threshold, the self-similarity score comprising a similarity measure of the received transaction relative to a set of prior transactions in the data storage relating to the account, wherein the computed self-similarity score indicates similarity of the received transaction to other transactions of the account in the set of prior transactions; and
determining the suggested action based on the computed fraud score and the computed self-similarity score.

15. The risk assessment computer system of claim 14, wherein the performed operation of determining comprises:
determining whether the computed fraud score comprises a high risk score or a low risk score relative to a predetermined threshold risk score value;
determining whether the computed self-similarity score comprises a high similarity score or a low similarity score relative to a predetermined threshold self-similarity score value; and
responsive to determining the fraud score as a high risk score or a low risk score and determining the self-similarity score as a high similarity score or a low similarity score, determining the suggested action.

16. The risk assessment computer system of claim 14, wherein the determined suggested action comprises contacting a holder of the account without declining the received transaction in response to a computer fraud score that is above a predetermined fraud threshold and a self-similarity score that is above a predetermined similarity threshold.

17. The risk assessment computer system of claim 14, wherein the determined suggested action comprises declining the transaction, in response to a computer fraud score that is above a predetermined fraud threshold and a self-similarity score that is below a predetermined similarity threshold.

18. The risk assessment computer system of claim 14, wherein the determined suggested action comprises approving the received transaction, in response to a computer fraud score that is below a predetermined fraud threshold and a self-similarity score that is above a predetermined similarity threshold.

19. The risk assessment computer system of claim 14, wherein the determined suggested action comprises approving the received transaction and monitoring the account for further activity, in response to a computer fraud score that is below a predetermined fraud threshold and a self-similarity score that is below a predetermined similarity threshold.

20. The risk assessment computer system of claim 14, wherein the performed operation of computing the self-similarity score comprises utilizing an Alternating Decision Tree.

21. The risk assessment computer system of claim 14, wherein a confidence margin is associated with the computed similarity score.

22. The risk assessment computer system of claim 14, wherein the computed self-similarity score comprises a probability that the received transaction is a transaction likely to be initiated by the account holder, regardless of the computed fraud score.

23. The risk assessment computer system of claim 14, wherein processing time for computing the self-similarity score is not greater than processing time for computing the fraud score.

24. The risk assessment computer system of claim 14, wherein the computed self-similarity score comprises a measure of proximity of the received transaction relative to a set of prior transactions over a shared data space.

25. The risk assessment computer system of claim 14, wherein the set of prior transactions in the data storage are included in the retrieved data.

26. The risk assessment computer system of claim 14, wherein the performed operations further comprise providing the suggested action to a financial transaction processing system.

27. A method of operating a risk assessment computer system, the method comprising:
retrieving data from data storage of the system in connection with a transaction received at the system relating to an account, wherein the data storage includes data relating to a plurality of accounts, each of which is associated with an account owner, and wherein the collection of accounts comprises an account population;
computing a fraud score in connection with the account to which the received transaction relates, wherein the computed fraud score indicates a probability of the account being in a compromised condition;
computing a self-similarity score in response to a computed fraud score that is above a predetermined threshold, the self-similarity score comprising a similarity measure of the received transaction relative to a set of prior transactions in the data storage relating to the account, wherein the computed self-similarity score indicates similarity of the received transaction to other transactions of the account in the set of prior transactions; and
determining the suggested action based on the computed fraud score and the computed self-similarity score.

28. The method of claim 27, wherein determining the suggested action comprises:
determining whether the computed fraud score comprises a high risk score or a low risk score relative to a predetermined threshold risk score value;
determining whether the computed self-similarity score comprises a high similarity score or a low similarity score relative to a predetermined threshold self-similarity score value; and
responsive to determining the fraud score as a high risk score or a low risk score and determining the self-similarity score as a high similarity score or a low similarity score, determining the suggested action.

29. The method of claim 27, wherein the determined suggested action comprises contacting a holder of the account without declining the received transaction in response to a computer fraud score that is above a predetermined fraud threshold and a self-similarity score that is above a predetermined similarity threshold.

30. The method of claim 27, wherein the determined suggested action comprises declining the transaction, in response to a computer fraud score that is above a predetermined fraud threshold and a self-similarity score that is below a predetermined similarity threshold.

31. The method of claim 27, wherein the determined suggested action comprises approving the received transaction, in response to a computer fraud score that is below a predetermined fraud threshold and a self-similarity score that is above a predetermined similarity threshold.

32. The method of claim 27, wherein the determined suggested action comprises approving the received transaction and monitoring the account for further activity, in response to a computer fraud score that is below a predetermined fraud threshold and a self-similarity score that is below a predetermined similarity threshold.

33. The method of claim 27, wherein computing the self-similarity score comprises utilizing an Alternating Decision Tree.

34. The method of claim 27, wherein a confidence margin is associated with the computed similarity score.

35. The method of claim 27, wherein the computed self-similarity score comprises a probability that the received transaction is a transaction likely to be initiated by the account holder, regardless of the computed fraud score.

36. The method of claim 27, wherein processing time for computing the self-similarity score is not greater than processing time for computing the fraud score.

37. The method of claim 27, wherein the computed self-similarity score comprises a measure of proximity of the received transaction relative to a set of prior transactions over a shared data space.

38. The method of claim 27, wherein the set of prior transactions in the data storage are included in the retrieved data.

39. The method of claim 27, further comprising providing the suggested action to a financial transaction processing system.
